(19) United States
(12) Patent Application Publication
(10) Pub. No.: US 2025/0010552 A1
(43) Pub. Date: Jan. 9, 2025

(54) TRANSFUSION PRESSURE CONTROL FOR THREE-DIMENSIONAL MANUFACTURING

(71) Applicant: Evolve Additive Solutions, Inc., Minnetonka, MN (US)

(72) Inventors: Alex J. Kossett, Minnetonka, MN (US); Zeiter Farah, Minneapolis, MN (US)

(21) Appl. No.: 18/697,316

(22) PCT Filed: Sep. 30, 2022
(86) PCT No.: PCT/US2022/045410

§ 371 Date: Mar. 29, 2024

Related U.S. Application Data
(60) Provisional application No. 63/250,977, filed on Sep. 30, 2021.

(51) Int. Cl. B29C 64/393; B33Y 50/02

(52) U.S. Cl. CPC B29C 64/393; B33Y 50/02

(57) ABSTRACT

Systems and methods for controlling the transfusion pressure in an additive manufacturing system are described. The system has a layer transfusion assembly that can include a build platform. The layer transfusion assembly is configured to transfuse the layers at a transfusion pressure in a layer-by-layer manner onto the build platform to print a three-dimensional part, and a controller is configured to set the transfusion pressure, wherein the transfusion pressure can vary along the x-direction of the build platform in a controlled manner.

### FIELD

The present disclosure relates to additive manufacturing systems for building three-dimensional (3D) parts and support structures. In particular, the present disclosure relates to additive manufacturing systems and processes for building 3D parts and support structures using an imaging process, such as electrostatography.

### BACKGROUND

Additive manufacturing systems are used to build 3D parts from digital representations of the 3D parts (e.g., STL format files) using one or more additive manufacturing techniques. Examples of commercially available additive manufacturing techniques include extrusion-based techniques, ink jetting, selective laser sintering, powder/binder jetting, electron-beam melting, and stereolithographic processes. For each of these techniques, the digital representation of the 3D part is initially sliced into multiple horizontal layers. For each sliced layer, a tool path is then generated, which provides instructions for the particular additive manufacturing system to form the given layer.

For example, in an extrusion-based additive manufacturing system, a 3D part or model may be printed from a digital representation of the 3D part in a layer-by-layer manner by extruding a flowable part material. The part material is extruded through an extrusion tip carried by a print head of the system and is deposited as a sequence of paths on a substrate in an x-y plane. The extruded part material fuses to previously deposited part material and solidifies upon a drop in temperature. The position of the print head relative to the substrate is then incremented along a z-axis (perpendicular to the x-y plane), and the process is then repeated to form a 3D part resembling the digital representation.

In fabricating 3D parts by depositing layers of a part material, supporting layers or structures are typically built underneath overhanging portions or in cavities of objects under construction, which are not supported by the part material itself. Support material also serves to maintain geometric stability of supported objects, such as thin walls. A support structure may be built utilizing the same deposition techniques by which the part material is deposited. The host computer generates additional geometry acting as a support structure for the overhanging or free-space segments of the 3D part being formed. Support material is then deposited from a second nozzle pursuant to the generated geometry during the printing process. The support material adheres to the modeling material during fabrication and is removable from the completed 3D part when the printing process is complete.

In addition to the aforementioned commercially available additive manufacturing techniques, a further additive manufacturing technique has emerged, where particles are first selectively deposited in an imaging process, forming a layer corresponding to a slice of the part to be made; the layers are bonded to each other, forming a part. This is a selective deposition process, in contrast to, for example, selective sintering, where the imaging and part formation happens simultaneously. The imaging step in a selective deposition process can be done using electrophotography. In two-dimensional (2D) printing, electrophotography (i.e., xerography) is a popular technology for creating 2D images on planar substrates, such as printing paper. Electrophotography systems include a conductive support drum coated with a photoconductive material layer, where latent electrostatic images are formed by charging and then image-wise exposing the photoconductive layer by an optical source. The latent electrostatic images are then moved to a developing station where toner is applied to charged areas of the photoconductive insulator to form visible images. The formed toner images are then transferred to substrates (e.g., the build surface of a part) and affixed to the substrates with heat or pressure. This technique is often called a Selective Thermoplastic Electrophotographic Process (“STEP”) printing process. Although STEP works very well, there remains opportunities for improvement.

### SUMMARY

Current practice for transfuse pressure control for solid support jobs is to target a given transfuse load value, and to adjust the load control window to the operator's opinion of the most-representative part of the build. However, this is a proxy for the process parameter of interest, which is transfuse pressure. This disclosure allows for the transfuse pressure-related parameter to be characterized as a “linear pressure” basis, in lbs/in or N/mm, and to calculate the target load on a given layer based on image content, and to adjust accordingly. The present system and method supports variable pixel counts and distributions of selective support jobs better than the current load-profiling feature, and allows operation without having to micromanage the load cell control window.

The present disclosure seeks to achieve constant transfuse pressure from layer to layer. Thus, an objective is to achieve a constant average pressure on each layer. As the total contact area of the transfuse roller changes from layer to layer, the system and method can proportionally adjust the applied average transfuse pressure. It is generally not possible to have a globally uniform pressure when part edges contact the transfuse roller, the system does not take account for that property. In reality, there will be higher pressure at edges and lower pressure on the interior of a layer. Similarly, small features will experience higher pressure than large features.

The transfuse nip is a fixed nip. That is, the distance from the platen to the transfuse roller is constant for a given transfusion. This distance is variable layer-to-layer, which is the mechanism by which the pressure is controlled. But within a layer it is fixed.

Thus, in an embodiment, a part profile is measured, averaged, and used as feedback to control the average pressure within a sampling zone that typically extends at least as long as the part does.

In an embodiment, a system for controlling the transfusion pressure in an additive manufacturing system comprises a layer transfusion assembly comprising a build platform, the layer transfusion assembly being configured to transfuse the layers at a transfusion pressure in a layer-by-layer manner onto the build platform to print a three-dimensional part; and a controller configured to set the transfusion force, wherein the transfusion force is varied from layer to layer to maintain a constant average pressure on each layer.

In an embodiment, a system for controlling the transfusion pressure in an additive manufacturing system, including a STEP manufacturing system, is disclosed. The STEP manufacturing system includes a layer transfusion assembly that typically includes a build platform. The layer transfusion assembly is configured to transfuse the layers at a transfusion pressure and elevated temperature in a layer-by-layer manner onto the build platform to print a three-dimensional part. Generally, a combination of part material, support material, and non-printed (air) regions make up the part volume. A controller is configured to set the transfusion pressure (generally applied by a transfusion roller), wherein the transfusion pressure can vary along the x-direction of the build platform, typically based upon the amount of part material, support material, and non-printed areas.

In an embodiment, a method for controlling the transfusion pressure in an additive manufacturing system is included, the method using a layer transfusion assembly can include a build platform, the layer transfusion assembly being configured to transfuse the layers at a transfusion pressure in a layer-by-layer manner onto the build platform to print a three-dimensional part, and establishing a target force for the transfusion assembly for a given layer, the target force dependent upon defined build parameters.

In an embodiment, the build parameters include substantially uniform average pressure for a given layer.

In an embodiment, the target force is controlled by height of the build platform.

In an embodiment, the target force is recalculated for each new layer but the pressure is substantially constant along each layer.

In an embodiment, a nip roller applies the transfusion force to the three-dimensional part and the target transfusion force can be varied from layer to layer.

In an embodiment, the height of the transfuse nip above the platform is substantially constant for each layer, but is changed between layers.

In an embodiment, the transfusion target force is a function of the toner coverage of the layer being deposited.

In an embodiment, the target force is a function of the number of pixels previously printed in a prior layer along a defined portion of the y-axis and x-axis.

In an embodiment, the controller can differentiate part material from support material and adjust force accordingly to obtain a substantially constant average pressure between layers.

In an embodiment, the part material is accounted for differently than the support material when calculating the target force.

In an embodiment, wherein calculating the target force takes the material properties of the roller transfusion element into account.

In an embodiment, wherein calculating the target force takes the material properties of the roller into account.

In an embodiment, the system can identify the transfusion element in use and automatically adjust the target force based on the material properties and dimensions of the roller.

In an embodiment, wherein calculating the target pressure includes: a) defining a sampling area, b) measuring the portion of the sampling area occupied in the next build layer that includes part or support material, c) scaling the target force to the portion of the sampling area can include part or support material so as to have a substantially constant average force applied to the part and support material.

In an embodiment, a method for controlling the transfuse pressure in an additive manufacturing system is included, the method a) defining target transfusion pressure, wherein the target transfusion pressure is a function of the dimensions of a three-dimensional part, and b) controlling a transfusion assembly to transfuse new layers onto the three-dimensional part at the target transfusion pressure by increasing or decreasing force applied to the top surface of the part.

In an embodiment, the target transfusion pressure is recalculated for each new layer.

In an embodiment, a nip roller applies a transfusion force to the three-dimensional part and the target transfusion force varies for each layer depending upon the three-dimensional part's top surface so as to maintain a substantially constant average force applied to each layer.

In an embodiment, the target pressure is a function of the toner coverage of the three-dimensional part.

In an embodiment, the target pressure is a function of number of pixels previously printed.

In an embodiment, the controller can differentiate part material from support material.

In an embodiment, the part material is accounted for differently than the support material when calculating the target pressure.

In an embodiment, wherein calculating the target pressure takes the material properties of the roller transfusion element into account.

In an embodiment, wherein calculating the target pressure takes the material properties of the roller into account.

In an embodiment, the control system can identify the transfusion element in use and automatically adjust the target pressure based on the material properties and dimensions of the roller.

In an embodiment, a method for controlling the transfuse pressure in an additive manufacturing system, wherein calculating the target pressure includes: a) defining a sampling distance in the X direction, wherein the sampling distance is greater than the width of the three-dimensional part, b) calculating the maximum number of pixels that could be printed spanning the sampling distance, c) defining a nip depth D, d) calculating a number of layers of the three-dimensional part that fall within the nip depth, e) calculating the number of printed pixels spanning the sampling distance for each of the number of layers and averaging the number of printed pixels over the number of layers, and f) scaling the target force by the ratio of the average number of printed pixels to the maximum number of pixels.

In an embodiment, the target transfusion pressure at a first location along the x-axis of the three-dimensional part is an average of a target transfusion pressures calculated at the first location and target transfusion pressures calculated at a second and third location, wherein the second and third locations are immediately adjacent to the first location.

In an embodiment, a system for controlling the transfusion pressure in an additive manufacturing system is included having a layer transfusion assembly can include a build platform, the layer transfusion assembly being configured to transfuse the layers at a transfusion pressure in a layer-by-layer manner onto the build platform to print a three-dimensional part, and a controller configured to set the transfusion force, wherein the transfusion force is varied from layer to layer to maintain a constant average pressure on each layer.

In an embodiment, the target force is recalculated for each new layer.

In an embodiment, a nip roller applies the transfusion pressure to the three-dimensional part and the target transfusion pressure varies with the position of the nip roller along the x-axis of the three-dimensional part.

In an embodiment, the target force is a function of number of pixels previously printed along the y axis of a three-dimensional part at a particular x-axis location.

In an embodiment, the controller can differentiate part material from support material and adjust pressure accordingly.

In an embodiment, the part material is accounted for differently than the support material when calculating the target force.

In an embodiment, the target force varies along the y direction of the three-dimensional part.

In an embodiment, wherein calculating the target force takes the material properties of the roller transfusion element into account.

In an embodiment, wherein calculating the target force takes the material properties of the roller into account.

In an embodiment, the target force control system can identify the transfusion element) in use and automatically adjust the target force based on the material properties and dimensions of the roller.

In an embodiment, the target transfusion pressure at a first location along the x-axis of the three-dimensional part is an average of a target transfusion pressures calculated at the first location and target transfusion pressures calculated at a second and third location, wherein the second and third locations are immediately adjacent to the first location.

In an embodiment, wherein calculating the target force includes: a) defining a sampling distance in the X direction, wherein the sampling distance is greater than the width of the three-dimensional part, b) calculating the maximum number of pixels that could be printed spanning the sampling distance, c) defining a nip depth D, d) calculating a number of layers of the three-dimensional part that fall within the nip depth, e) calculating the number of printed pixels spanning the sampling distance for each of the number of layers and averaging the number of printed pixels over the number of layers, and f) scaling the target force by the ratio of the average number of printed pixels to the maximum number of pixels.

In an embodiment, a method for controlling the transfuse pressure in an additive manufacturing system is included, the method a) defining target transfusion pressure, wherein the target transfusion pressure is a function of the x position of a three-dimensional part, and b) controlling a transfusion assembly to transfuse new layers onto the three-dimensional part at the target transfusion pressure.

In an embodiment, the target transfusion pressure is recalculated for each new layer.

In an embodiment, a nip roller applies the transfusion pressure to the three-dimensional part and the target transfusion pressure varies with the position of the nip roller along the x-axis of the three-dimensional part.

In an embodiment, the target force is a function of number of pixels previously printed along the y axis of a three-dimensional part at a particular x-axis location.

In an embodiment, the controller can differentiate part material from support material.

In an embodiment, the part material is accounted for differently than the support material when calculating the target force.

In an embodiment, the target force varies along the X direction of the three-dimensional part.

In an embodiment, a method for controlling the transfuse pressure in an additive manufacturing system, wherein calculating the target force includes: a) defining a sampling distance in the X direction, wherein the sampling distance is greater than the width of the three-dimensional part, b) calculating the maximum number of pixels that could be printed spanning the sampling distance, c) defining a nip depth D, d) calculating a number of layers of the three-dimensional part that fall within the nip depth, e) calculating the number of printed pixels spanning the sampling distance for each of the number of layers and averaging the number of printed pixels over the number of layers, and f) scaling the target force by the ratio of the average number of printed pixels to the maximum number of pixels.

In an embodiment, the target transfusion pressure at a first location along the x-axis of the three-dimensional part is an average of a target transfusion pressures calculated at the first location and target transfusion pressures calculated at a second and third location, wherein the second and third locations are immediately adjacent to the first location.

In an embodiment, the target force is recalculated for each new layer, since each layer can have a different amount of part material, support material, and non-printed area. In an embodiment, a nip roller applies the transfusion pressure to the three-dimensional part and the target transfusion pressure varies with the position of the nip roller along the x-axis of the three-dimensional part, the x-axis being the axis along which the nip roller progresses along the part surface.

In an embodiment the target force is a function of the density of the three-dimensional part in the region being transfused. In some embodiments the target force is a function of the number of pixels previously printed along the y-axis of a three-dimensional part at a particular x-axis location. Thus, the target force can be varied depending upon the currently printed pixels as well as those in previously printed layers. Generally, the most recently printed layers are more heavily weighted for the pressure determination.

As noted above, in an embodiment, the controller system and process differentiate part material from support material and can also differentiate between various types of build material and support material. Typically, the part material is accounted for differently than the support material when calculating the target force.

In an embodiment, the target force varies along the y direction of the three-dimensional part.

In addition, the target force calculation can take the material properties of the transfusion element (generally a roller) into account. For example, some transfusion elements are more compliant than others, which can result in adjustments to target force. Generally, the more compliant the surface of the transfusion element the great the pressure that is applied. In an embodiment, the target force control system can identify the transfusion element in use and automatically adjust the target force based on the material properties and dimensions of the roller.

In an embodiment, calculating the target force includes: a) defining a sampling distance in the X direction, wherein the sampling distance is greater than the width of the three-dimensional part, b) calculating the maximum number of pixels that could be printed spanning the sampling distance, c) defining a nip depth D along with d) calculating a number of layers of the three-dimensional part that fall within the nip depth, e) calculating the number of printed pixels spanning the sampling distance for each of the number of layers and averaging the number of printed pixels over the number of layers, and f) scaling the target force by the ratio of the average number of printed pixels to the maximum number of pixels.

In an embodiment, the target transfusion pressure at a first location along the x-axis of the three-dimensional part is an average of target transfusion pressures calculated at a first location and target transfusion pressures calculated at a second and third location, wherein the second and third locations are immediately adjacent to the first location.

In an embodiment, a method for controlling the transfuse pressure in an additive manufacturing system is included, the method: a) defining target transfusion pressure, wherein the target transfusion pressure is a function of the x position of a three-dimensional part, and b) controlling a transfusion assembly to transfuse new layers onto the three-dimensional part at the target transfusion pressure. Optionally the target transfusion pressure is recalculated for each new layer. Generally, a nip roller applies the transfusion pressure to the three-dimensional part and the target transfusion pressure varies with the position of the nip roller along the x-axis of the three-dimensional part.

This roller can be referred to as a “transfusion element”. In an embodiment, the target force is a function of the density of the three-dimensional part.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The terms “about” and “substantially” are used herein with respect to measurable values and ranges due to expected variations known to those skilled in the art (e.g., limitations and variabilities in measurements).

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic diagram of an additive manufacturing system in accordance with an embodiment of the present disclosure.

FIG. 2 is a top photographic view of a plurality of printed parts on a platen, in accordance with various embodiments herein.

FIG. 3 is a graph view of a load log of a transfusion roller from the parts of FIG. 2.

FIG. 4 is a graph showing load profile plotted alongside calculated fill.

FIG. 5 is a graph showing total load by layer during creation of a multi-layer additive manufacturing product.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

The present disclosure relates to a system and method for controlling layer transfusion pressure to compensate of deformations on a nip roller in an electrostatography-based additive manufacturing system. The present disclosure can be utilized with any electrostatography-based additive manufacturing system, the present disclosure will be described in association in an electrophotography-based (EP) additive manufacturing system. However, the present disclosure is not limited to an EP based additive manufacturing system and can be utilized with any electrostatography-based additive manufacturing system.

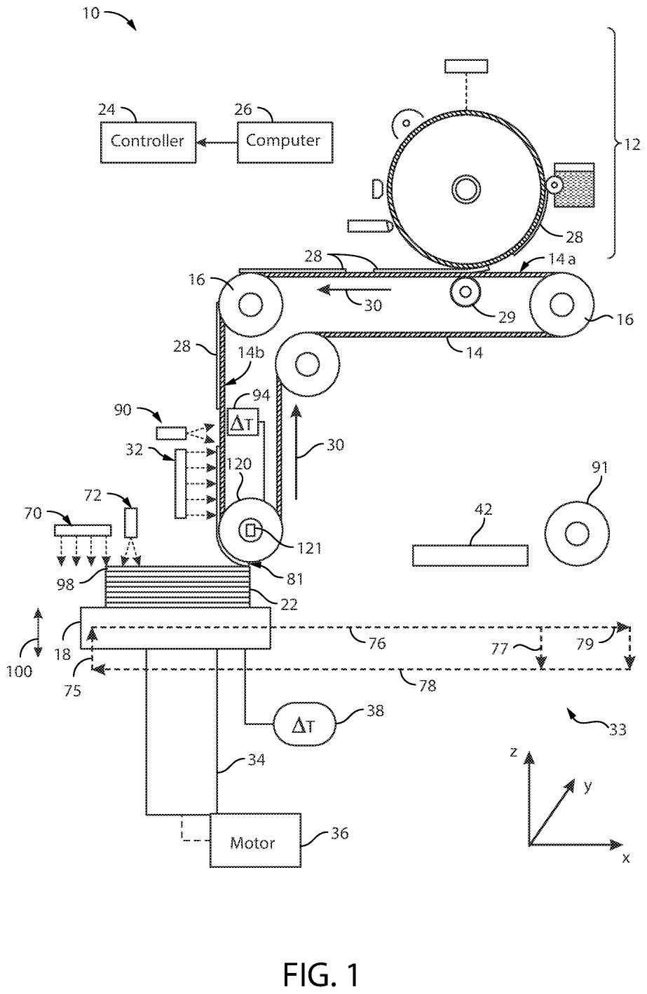

FIG. 1 provides a schematic diagram of an exemplary additive manufacturing system 10 for printing 3D parts and support structures in accordance with various embodiments. System 10 uses electrophotography to print successive layers of the 3D part and support structure.

In the embodiment shown, system 10 includes at least one EP engine 12 (and typically two or more EP engines that have different materials), a conveyor consisting of belt 14 and rollers 16, a build platform 18, a gantry 34, and belt-to-part transfer assembly 33 for printing 3D parts (e.g., 3D part 22) and any associated support structures (not shown). Examples of suitable components and functional operations for system 10 include those disclosed in U.S. Pat. Nos. 8,879,957 and 8,488,994.

In alternative embodiments, system 10 may include different imaging engines for imaging the layers. As discussed below, the partially unsupported layer transfer technique focuses on the transfer of part layers from belt 14 (or other transfer medium) to build platform 18 (or to the 3D part 22 being printed on build platform 18) to form unsupported portions on 3D part 22, rather than focusing on the particular imaging engine. However, the layer transfer technique is particularly suitable for use with electrophotography-based additive manufacturing systems (e.g., system 10).

System 10 also includes controller 24, which is one or more control circuits, microprocessor-based engine control systems, and/or digitally controlled imaging processor systems, and which is configured to operate the components of system 10 in a synchronized manner based on printing instructions received from host computer 26, including changing pressure applied to the top of parts. Host computer 26 is one or more computer-based systems configured to communicate with controller 24 to provide the print instructions (and other operating information). For example, host computer 26 may transfer information to controller 24 that relates to the sliced layers of 3D part 22 (and any support structures), thereby allowing system 10 to print 3D part 22 in a layer-by-layer manner.

The imaged layers 28 of the thermoplastic-based powder are then rotated to a first transfer region in which layers 28 are transferred from EP engine 12 to belt 14. Belt 14 is an example transfer medium or conveyor for transferring or otherwise conveying the imaged layers 28 from EP engine 12 to build platform 18 with the assistance of transfer roller 120. In the shown embodiment, belt 14 includes front or transfer surface 14a and rear or contact surface 14b, where front surface 14a faces EP engine 12. As discussed below, in some embodiments, belt 14 may be a multiple-layer belt with a low-surface-energy film that defines front surface 14a, and which is disposed over a base portion that defines rear surface 14b.

System 10 may also include biasing mechanism 29, which is configured to induce an electrical potential through the belt 14 to electrostatically attract part layers 28 of the thermoplastic-based powder from EP engine 12 to belt 14.

Rollers 16 are a series of drive and/or idler rollers or pulleys that are configured to maintain tension on belt 14 while belt 14 rotates in the rotational direction of arrows 30. System 10 may also include service loops (not shown), such as those disclosed in U.S. Pat. No. 8,488,994.

Belt 14 conveys successive layers 28 from EP engine 12 to belt-to-part transfer assembly 33, which transfers each part layer onto previously transferred layers of part 22 in a layer-by-layer manner. Belt-to-part transfer assembly 33 optionally includes a selective fusing heater 90, a layer transfer heater 32, a uniform part transfer heater, a selective part transfer heater 72, a nip or transfer roller 120, an air knife or air tunnel 42 and a cooling roller 91. However, other configurations of belt-to-part transfer assembly 33 are also contemplated.

Transfer of a next layer 28 onto a previously transferred layer 98 begins by heating the fully supported layer 28 on belt 14 to near an intended transfer temperature using layer transfer heater 32 prior to reaching transfer roller 120. Examples of suitable devices for heater 32 include non-contact radiant heaters (e.g., infrared heaters or microwave heaters), convection heating devices (e.g., heated air blowers), contact heating devices (e.g., heated rollers and/or platens), combinations thereof, and the like, where non-contact radiant heaters are preferred. Each layer 28 desirably passes by (or through) heater 32 for a sufficient residence time to heat the layer 28 to the intended transfer temperature.

Additionally, platen gantry 34 moves build platform 18 along the positive z-axis in the direction of arrow 75 and then, along, or through uniform part transfer heater in the positive x direction of arrow 76. Gantry 34 is operated by a motor 36 based on commands from controller 24, where motor 36 may be an electrical motor, a hydraulic system, a pneumatic system, or the like. In the shown embodiments, build platform 18 is heatable with heating element 38 (e.g., an electric heater). Heating element 38 is configured to heat and maintain build platform 18 at an elevated temperature that is greater than room temperature (e.g., 25° C.), such as at the desired average part temperature of 3D part 22. This allows build platform 18 to assist in maintaining 3D part 22 at this average part temperature.

In further embodiments, the temperature of build platform 18 is the bulk temperature (near T_{g}, or 120 degrees Celsius for ABS) within about 100 mils of the build plane. As the part grows in Z, the build platform temperature drops linearly with Z, generating a constant low thermal gradient and heat flow in Z, at roughly 18 degrees Celsius/inch. This reduces the risk of narrow vertical structures (posts and beams) becoming unstable. The gentle cooling rate is not sufficient to create substantial curl, but is sufficient to make tall parts mechanically robust.

Heater 70 heats the top surface of previously transferred layer 98 to an elevated temperature, such as at the same transfer temperature as heated layer 28 (or other suitable elevated temperature). Examples of suitable devices for uniform part transfer heater include non-contact radiant heaters (e.g., infrared heaters or microwave heaters), convection heating devices (e.g., heated air blowers), contact heating devices (e.g., heated rollers and/or platens), combinations thereof, and the like, where non-contact radiant heaters are preferred.

Belt 14 then moves the heated layer 28 to a predetermined registration location 81, as shown. The z position of build platform 18 established by moving the build platform 18 in the positive z direction of arrow 75 causes a pressure to be applied to heated layer 28 as belt 14 moves heated layer 28 between transfer roller 120 and build platform 18 or part 22. The pressure on heated layer 28 is desirably high enough to transfer heated layer 28 to the previously transferred layer 98 of part 22 (or to build platform 18). However, the pressure is also desirably balanced, including as described herein to maintain substantially constant pressure during a transfuse cycle, to prevent compressing 3D part 22 too much, thereby allowing 3D part 22 to maintain its dimensional integrity. As described herein, variation of the pressure can be based upon the part being printed (part vs. support material, part density, material properties, nip roller properties, etc.)

While build platform 18 remains engaged with belt 14, gantry 34 moves build platform 18 (and 3D part 22) along the x-axis in the direction of arrow 76, at a rate that is synchronized with the rotational rate of belt 14 in the direction of belt 14 at the bottom of transfer roller 120. This presses the belt 14 and the heated layer 28 between the top layer 98 of 3D part 22 and transfer roller 120. Due to the heat and pressure, pressed layer 28 separates and disengages from belt 14 and transfers to top layer 98 of 3D part 22 at transfer roller 120.

Gantry 34 then moves transferred layer 28 past an air tunnel 42, such as an air knife or air tunnel 42, which cools the top exposed surface of the transferred layers to cool part 22. Gantry 34 then drops build platform 18 down along path 77, before moving build platform 18 in the negative x direction along path 78. The process is then repeated for the next layer.

During a transfusion process, when an image layer 28 is transferred to a build platform 18, the image layer 28 and build platform 18 make contact at a registration location 81, which is also a transfer or transfuse roller 120 nip point. Transfuse roller 120 may be a nip roller which may be an exemplary heatable element or heatable layer transfusion element, which is configured to rotate around a fixed axis with the movement of the belt 14. In the shown embodiment, the nip roller 70 is heatable with an optional heating element 94 (e.g., an electric heater). The heating element 94 is configured to heat and maintain nip roller 70 at an elevated temperature that is greater than room temperature (25° C.), such as at a desired transfer temperature for the image layers 28.

During rotation of the transfuse roller 120 and its contact with previous layers 98, the radius of an outer surface of a rubber-coated roller such as that used for transfuse roller 120 varies due to runout variations from the rotation of the roller, and/or radial variations in the roller rubber hardness/durometer. Inspection of the load cells 121 holding the bearings on the ends of the transfuse roller show significant (from less than +/−5% up to +/−30%) variations in transfuse force or transfuse pressure within and between frames. While some of this variation is due to part height effects, the majority appears due to variations in the transfuse roller effective radius or hardness with respect to axial orientation (e.g., radial runout).

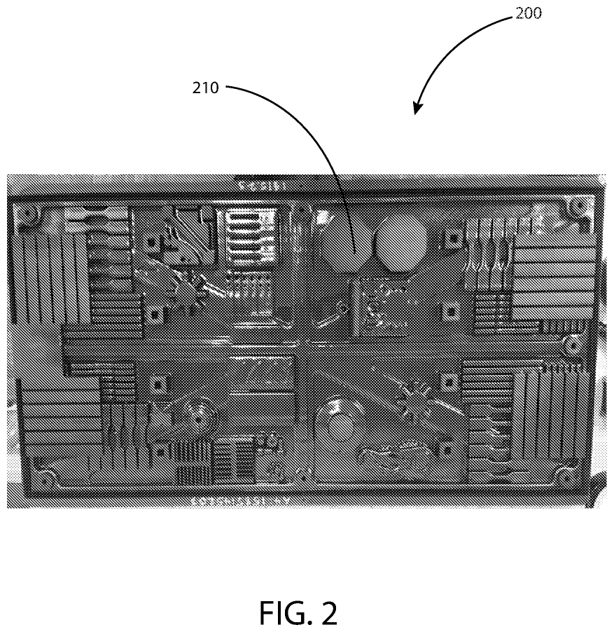

FIG. 2 is a top photographic view of a plurality of printed parts on a platen, in accordance with various embodiments herein. FIG. 2 shows the material distribution (leading edge on left). Note the vast empty spaces. This job is about ⅓ each part, support, and air volume.

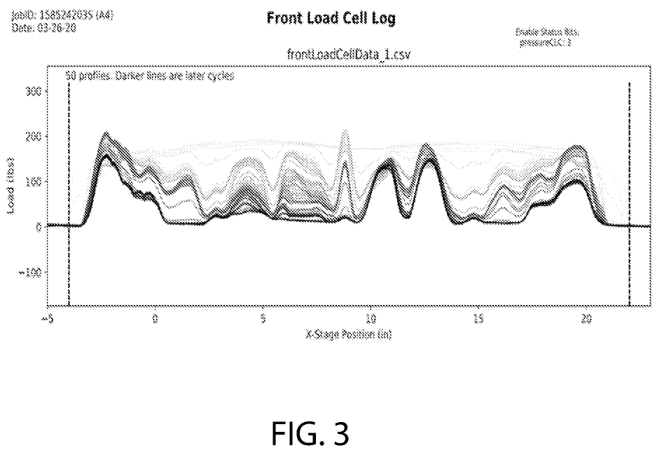

FIG. 3 is a graph view of a load log of a transfusion roller from the parts of FIG. 2. FIG. 3 shows a series of load cell profiles from the job (leading edge is left). Note that: The sampling window is set to sample more than the full build length, and the feedback variable is the average over this whole length; the faintest lines—the earliest layers—have a fairly consistent load along the full image length because they had 100% toner coverage; as the build progresses, the profiles gradually drop on average as fill reduces; peaks from the octagonal parts, which are the full build height, are clearly visible around 10 and 13 inches; and the tall parts of the build maintain their local peaks, despite the gradual reduction in global average setpoint.

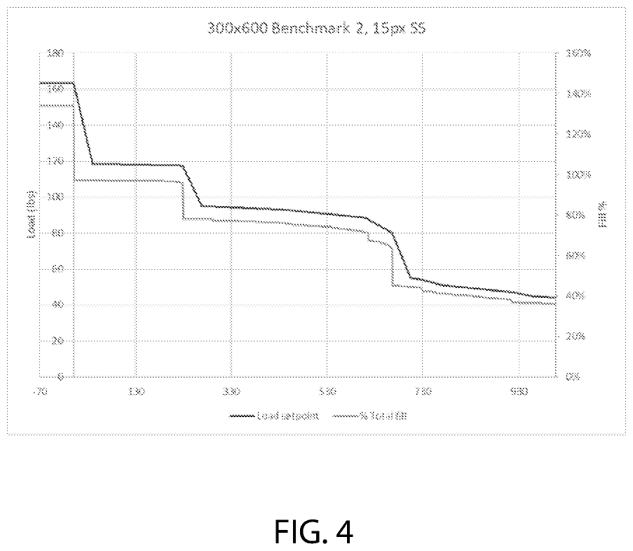

FIG. 4 is a graph showing load profile plotted alongside calculated fill. FIG. 4 is an example load profile plotted alongside a calculated fill %, which is the percentage of the load cell sampling window filled with toner. The fill % is greater than 100% at the start because in this calculation the image area was used as the basis for the fill %, but the platen is both wider and longer than the image, so it counts as greater-than-100%. The load target trails the fill % because it is based on a moving average of the fill % to account for nip depth.

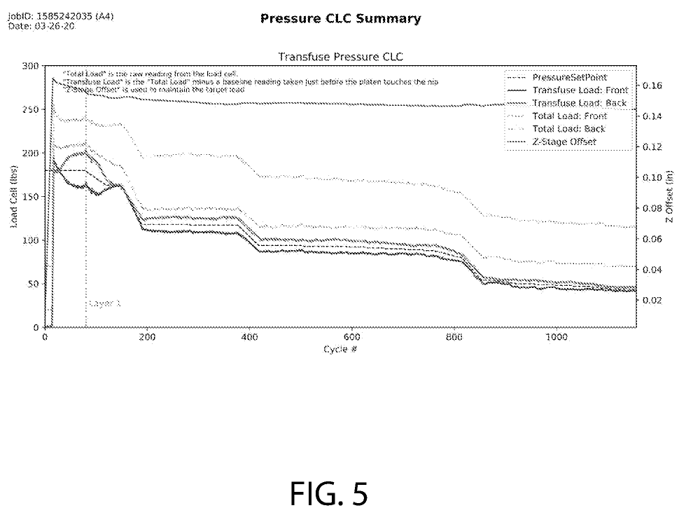

FIG. 5 is a graph showing total load by layer during creation of a multi-layer additive manufacturing product. FIG. 5 shows a plot of load cell feedback by layer for the job (same benchmark, different run). Note that the Z-stage offset is fairly flat under this algorithm. Assuming consistent toner M/A (which based on ToP feedback it was), this indicates a fairly constant nip depth, or fairly constant pressure in the regions of contact with the transfuse roller.

Under the disclosure of present application, the transfuse pressure-related parameter is determined as a “linear pressure” basis, in lbs/in² or N/mm², and used to calculate the target load on a given layer based on image content. Such systems and methods can support variable pixel counts and distributions of selective support jobs better than current load-profiling techniques, and can allow operation without having an operator micromanage the load cell control window.

Components of an example algorithm include:
i) defining a configurable function “P” that specifies a target linear pressure (in lbs/in or N/mm) for a given layer.
ii) defining a load cell sampling distance “L”. Typically L is greater than the part build length (such as 26 in). This may be universal or configurable for specific jobs. In an example construction the algorithm does not depend on scaling this to the actual build length (i.e. 26″ could be used for a 10″ long build). However, the load profile of the build area is generally fully sampled.
iii) calculate “Pix_full”, which is the number of pixels that would exist over the platen width “W” and over the load cell sampling distance “L”. It is often important that the platen width W be accurate so that the initial layers can be transfused at the target force.
iv) defining a configurable nip depth “D”, which can be used to average a number of layers to account for the soft nip.
v) calculation of the number of layers M within nip depth D, based on layer thickness.
vi) calculation of “Pix_avg(N)” for a given layer, which is the average number of pixels over the last M layers. The platen itself counts as an infinite number of prior layers with pixel count Pix_full. At startup, the target load will be based on Pix_Full. The very first layer's load will be based on M-1 layers of Pix_full and the first layer's content, etc.
vii) for each layer's target force P(N), calculating the Load_Full(N)=W*P(N). This is the load that would be targeted if the build stretched along the full sampling distance at the platen width W.
viii) on each layer, calculate Load_Target(N)=Load_Full(N)*Pix_avg(N)/Pix_full. This will be the load target for layer N. Generally it is desirable that the load cell is sampled over the full length L used in this calculation, and that the full build area is sampled (operator's responsibility). This is what permits this algorithm to be used on builds of arbitrary material distribution and size, because it will proportionally reduce the target average load based on the actual amount of material the load cell encounters over the full sampling area.

It will be understood that the foregoing is just one example process, and these various steps can be recombined with other steps, and that some or all steps can be used, and that the order of calculation can be varied.

FIG. 2 is a picture of an object 200 formed using an apparatus and process as described in herein to show the material distribution (leading edge on left). This part has vast empty spaces, with the overall composition being about ⅓ each part, support, and air volume.

FIG. 3 is a series of load cell profiles from production of the object 200 of FIG. 2 (leading edge is left). Note that the sampling window is set to sample more than the full build length, and the feedback variable is the average over this whole length. The faintest lines (the earliest layers) have a fairly consistent load along the full image length because they had 100 percent toner coverage. As the build progresses, the profiles gradually drop on average as fill is reduced. Peaks from the octagonal parts 210, which are the full build height, are clearly visible around about 10 to 13 inches. Thus, the tall parts of the build maintain their local peaks, despite the gradual reduction in global average setpoint.

In an embodiment, a system for controlling the transfusion pressure in an additive manufacturing system, including a STEP manufacturing system, is disclosed. The STEP manufacturing system includes a layer transfusion assembly that typically includes a build platform. The layer transfusion assembly is configured to transfuse the layers at a transfusion pressure and elevated temperature in a layer-by-layer manner onto the build platform to print a three-dimensional part. Generally a combination of part material, support material, and non-printed (air) regions make up the part volume. A controller is configured to set the transfusion pressure (generally applied by a transfusion roller), wherein the transfusion pressure can vary along the x-direction of the build platform, typically based upon the amount of part material, support material, and non-printed areas.

In an embodiment, the target force is recalculated for each new layer, since each layer can have a different amount of part material, support material, and non-printed area. In an embodiment, a nip roller applies the transfusion pressure to the three-dimensional part, and the target transfusion pressure varies with the position of the nip roller along the x-axis of the three-dimensional part, the x-axis being the axis along which the nip roller progresses along the part surface.

In an embodiment the target force is a function of the density of the three-dimensional part in the region being transfused. In some embodiment the target force is a function of the number of pixels previously printed along the y axis of a three-dimensional part at a particular x-axis location. Thus, the target force can be varied depending upon the currently printed pixels as well as those in previously printed layers. Generally the most recently printed layers are more heavily weighted for the pressure determination.

As noted above, in an embodiment, the controller system and process differentiate part material from support material, and can also differentiate between various types of build material and support material. Typically the part material is accounted for differently than the support material when calculating the target force.

In an embodiment, the target force varies along the y direction of the three-dimensional part.

In addition, the target force calculation can include the material properties of the transfusion element (generally a roller) into account. For example, some transfusion elements are more compliant than others, which can result in adjustments to target force. Generally, the more compliant the surface of the transfusion element the great the pressure that is applied. In an embodiment, wherein the target force control system can identify the transfusion element in use and automatically adjust the target force based on the material properties and dimensions of the roller.

In an embodiment, calculating the target force includes: a) defining a sampling distance in the X direction, wherein the sampling distance is greater than the width of the three-dimensional part, b) calculating the maximum number of pixels that could be printed spanning the sampling distance, c) defining a nip depth D along with d) calculating a number of layers of the three-dimensional part that fall within the nip depth, e) calculating the number of printed pixels spanning the sampling distance for each of the number of layers and averaging the number of printed pixels over the number of layers, and f) scaling the target force by the ratio of the average number of printed pixels to the maximum number of pixels.

In an embodiment, the target transfusion pressure at a first location along the x-axis of the three-dimensional part is an average of a target transfusion pressures calculated at a first location and target transfusion pressures calculated at a second and third location, wherein the second and third locations are immediately adjacent to the first location.

In an embodiment, a method for controlling the transfuse pressure in an additive manufacturing system is included, the method a) defining target transfusion pressure, wherein the target transfusion pressure is a function of the x position of a three-dimensional part, b) controlling a transfusion assembly to transfuse new layers onto the three-dimensional part at the target transfusion pressure. Optionally the target transfusion pressure is recalculated for each new layer. Generally a nip roller applies the transfusion pressure to the three-dimensional part and the target transfusion pressure varies with the position of the nip roller along the x-axis of the three-dimensional part. This roller can be referred to as a “transfusion element”. In an embodiment, the target force is a function of the density of the three-dimensional part.

The main comment that might affect the application is to transition from ‘adjusting the transfuse pressure with x’ to ‘adjusting the transfuse force with x’.

This distinction rattles through both the specification and the claims, and probably matters.

In some embodiments the transfuse roller passes inches above the build platform (zero pressure); and thus the controlled pressure occurs only to the build surface of the part. The transfuse force will vary with the fraction of the nip that is pressing on build surface; such that this force will change significantly in x (such as, optionally, a factor of 10), while the pressure (lbf/inch²) experienced by the build surface may change less or potentially not at all.

As a part gets taller, its build surface compliance increases (it becomes more pillow-like). For some materials, such as ABS, the part gets to be about as soft as the present transfuse roller around z=0.7″. The area over which force is being distributed transitions from the nip compression with (which includes both the roller and the part softness) to the x*y area of the part features passing under the roller. Optionally, in practice, the transfuse force (and pressure) are set by assigning a z-position(x) to the platen as it passes under the transfuse roller.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method for controlling the transfusion pressure in an additive manufacturing system comprising:
using a layer transfusion assembly comprising a build platform, the layer transfusion assembly being configured to transfuse the layers at a transfusion pressure in a layer-by-layer manner onto the build platform to print a three-dimensional part; and
establishing a target force for the transfusion assembly for a given layer, the target force dependent upon defined build parameters.

2. The method for controlling the transfusion pressure in an additive manufacturing system of claim 1, wherein the build parameters comprise substantially uniform average pressure for a given layer.

3. The method for controlling the transfusion pressure in an additive manufacturing system of claim 1, wherein the target force is controlled by height of the build platform.

4. The method for controlling the transfusion pressure in an additive manufacturing system of claim 1, wherein the target force is recalculated for each new layer but the pressure is substantially constant along each layer.

5. The method for controlling the transfusion pressure in an additive manufacturing system of claim 1, wherein a nip roller applies the transfusion force to the three-dimensional part and the target transfusion force can be varied from layer to layer.

6. The method for controlling the transfusion pressure in an additive manufacturing system of claim 1, wherein the height of the transfuse nip above the platform is substantially constant for each layer, but is changed between layers.

7. The method for controlling the transfusion pressure in an additive manufacturing system of claim 1, wherein the transfusion target force is a function of the toner coverage of the layer being deposited.

8. The method for controlling the transfusion pressure in an additive manufacturing system of claim 1, wherein the target force is a function of the number of pixels previously printed in a prior layer along a defined portion of the y-axis and x-axis.

9. The method for controlling the transfusion pressure in an additive manufacturing system of claim 1, wherein the controller can differentiate part material from support material and adjust force accordingly to obtain a substantially constant average pressure between layers.

10. The method for controlling the transfusion pressure in an additive manufacturing system of claim 7, wherein the part material is accounted for differently than the support material when calculating the target force.

11. The method for controlling the transfusion pressure in an additive manufacturing system of claim 1, wherein calculating the target force takes the material properties of the roller transfusion element into account.

12. The method for controlling the transfusion pressure in an additive manufacturing system of claim 1, wherein calculating the target force takes the material properties of the roller into account.

13. The method for controlling the transfusion pressure in an additive manufacturing system of claim 1, wherein the system can identify the transfusion element in use and automatically adjust the target force based on the material properties and dimensions of the roller.

14. The method for controlling the transfusion pressure in an additive manufacturing system of claim 1, wherein calculating the target pressure comprises:
a) defining a sampling area;
b) measuring the portion of the sampling area occupied in the next build layer that comprises part or support material;
c) scaling the target force to the portion of the sampling area comprising part or support material so as to have a substantially constant average force applied to the part and support material.

15. A method for controlling the transfuse pressure in an additive manufacturing system comprising:
a) defining target transfusion pressure, wherein the target transfusion pressure is a function of the dimensions of a three-dimensional part; and
b) controlling a transfusion assembly to transfuse new layers onto the three-dimensional part at the target transfusion pressure by increasing or decreasing force applied to the top surface of the part.

16. The method for controlling the transfuse pressure in an additive manufacturing system of claim 15, wherein the target transfusion pressure is recalculated for each new layer.

17. The method for controlling the transfuse pressure in an additive manufacturing system of claim 15, wherein a nip roller applies a transfusion force to the three-dimensional part and the target transfusion force varies for each layer depending upon the three-dimensional part's top surface so as to maintain a substantially constant average force applied to each layer.

18. The method for controlling the transfuse pressure in an additive manufacturing system of claim 15, wherein the target pressure is a function of the toner coverage of the three-dimensional part.

19. The method for controlling the transfuse pressure in an additive manufacturing system of claim 15, wherein the target pressure is a function of number of pixels previously printed.

20. The method for controlling the transfuse pressure in an additive manufacturing system of claim 15, wherein the controller can differentiate part material from support material.

21. The method for controlling the transfuse pressure in an additive manufacturing system of claim 15, wherein the part material is accounted for differently than the support material when calculating the target pressure.

22. The method for controlling the transfuse pressure in an additive manufacturing system of claim 15, wherein calculating the target pressure takes the material properties of the roller transfusion element into account.

23. The method for controlling the transfuse pressure in an additive manufacturing system of claim 15, wherein calculating the target pressure takes the material properties of the roller into account.

24. The method for controlling the transfuse pressure in an additive manufacturing system of claim 15, wherein the control system can identify the transfusion element in use and automatically adjust the target pressure based on the material properties and dimensions of the roller.

25. A method for controlling the transfuse pressure in an additive manufacturing system, wherein calculating the target pressure comprises:
a) defining a sampling distance in the X direction, wherein the sampling distance is greater than the width of the three-dimensional part;
b) calculating the maximum number of pixels that could be printed spanning the sampling distance;
c) defining a nip depth D;
d) calculating a number of layers of the three-dimensional part that fall within the nip depth;
e) calculating the number of printed pixels spanning the sampling distance for each of the number of layers and averaging the number of printed pixels over the number of layers; and
f) scaling the target force by the ratio of the average number of printed pixels to the maximum number of pixels.

26. The method for controlling the transfuse pressure in an additive manufacturing system of claim 25, wherein the target transfusion pressure at a first location along the x-axis of the three-dimensional part is an average of a target transfusion pressures calculated at the first location and target transfusion pressures calculated at a second and third location, wherein the second and third locations are immediately adjacent to the first location.

27. A system for controlling the transfusion pressure in an additive manufacturing system comprising:
a layer transfusion assembly comprising a build platform, the layer transfusion assembly being configured to transfuse the layers at a transfusion pressure in a layer-by-layer manner onto the build platform to print a three-dimensional part; and
a controller configured to set the transfusion force, wherein the transfusion force is varied from layer to layer to maintain a constant average pressure on each layer.

28. The system for controlling the transfusion pressure in an additive manufacturing system of claim 27, wherein the target force is recalculated for each new layer.

29. The system for controlling the transfusion pressure in an additive manufacturing system of claim 27, wherein a nip roller applies the transfusion pressure to the three-dimensional part and the target transfusion pressure varies with the position of the nip roller along the x-axis of the three-dimensional part.

30. The system for controlling the transfusion pressure in an additive manufacturing system of claim 27, wherein the target force is a function of number of pixels previously printed along the y axis of a three-dimensional part at a particular x-axis location.

31. The system for controlling the transfusion pressure in an additive manufacturing system of claim 27, wherein the controller can differentiate part material from support material and adjust pressure accordingly.

32. The system for controlling the transfusion pressure in an additive manufacturing system of claim 27, wherein the part material is accounted for differently than the support material when calculating the target force.

33. The system for controlling the transfusion pressure in an additive manufacturing system of claim 27, wherein the target force varies along the y direction of the three-dimensional part.

34. The system for controlling the transfusion pressure in an additive manufacturing system of claim 27, wherein calculating the target force takes the material properties of the roller transfusion element into account.

35. The system for controlling the transfusion pressure in an additive manufacturing system of claim 27, wherein calculating the target force takes the material properties of the roller into account.

36. The system for controlling the transfusion pressure in an additive manufacturing system of claim 27, wherein the target force control system can identify the transfusion element) in use and automatically adjust the target force based on the material properties and dimensions of the roller.

37. The system for controlling the transfusion pressure in an additive manufacturing system of claim 27, wherein the target transfusion pressure at a first location along the x-axis of the three-dimensional part is an average of a target transfusion pressures calculated at the first location and target transfusion pressures calculated at a second and third location, wherein the second and third locations are immediately adjacent to the first location.

38. The system for controlling the transfusion pressure in an additive manufacturing system of claim 27, wherein calculating the target force comprises:
a) defining a sampling distance in the X direction, wherein the sampling distance is greater than the width of the three-dimensional part;
b) calculating the maximum number of pixels that could be printed spanning the sampling distance;
c) defining a nip depth D;
d) calculating a number of layers of the three-dimensional part that fall within the nip depth;
e) calculating the number of printed pixels spanning the sampling distance for each of the number of layers and averaging the number of printed pixels over the number of layers; and
f) scaling the target force by the ratio of the average number of printed pixels to the maximum number of pixels.

39. A method for controlling the transfuse pressure in an additive manufacturing system comprising:
a) defining target transfusion pressure, wherein the target transfusion pressure is a function of the x position of a three-dimensional part; and
b) controlling a transfusion assembly to transfuse new layers onto the three-dimensional part at the target transfusion pressure.

40. The method for controlling the transfuse pressure in an additive manufacturing system of claim 39, wherein the target transfusion pressure is recalculated for each new layer.

41. The method for controlling the transfuse pressure in an additive manufacturing system of claim 39, wherein a nip roller applies the transfusion pressure to the three-dimensional part and the target transfusion pressure varies with the position of the nip roller along the x-axis of the three-dimensional part.

42. The method for controlling the transfuse pressure in an additive manufacturing system of claim 39, wherein the target force is a function of number of pixels previously printed along the y axis of a three-dimensional part at a particular x-axis location.

43. The method for controlling the transfuse pressure in an additive manufacturing system of claim 39, wherein the controller can differentiate part material from support material.

44. The method for controlling the transfuse pressure in an additive manufacturing system of claim 39, wherein the part material is accounted for differently than the support material when calculating the target force.

45. The method for controlling the transfuse pressure in an additive manufacturing system of any of claim 39, wherein the target force varies along the X direction of the three-dimensional part.

46. A method for controlling the transfuse pressure in an additive manufacturing system, wherein calculating the target force comprises:
a) defining a sampling distance in the X direction, wherein the sampling distance is greater than the width of the three-dimensional part;
b) calculating the maximum number of pixels that could be printed spanning the sampling distance;
c) defining a nip depth D;
d) calculating a number of layers of the three-dimensional part that fall within the nip depth;
e) calculating the number of printed pixels spanning the sampling distance for each of the number of layers and averaging the number of printed pixels over the number of layers; and
f) scaling the target force by the ratio of the average number of printed pixels to the maximum number of pixels.

47. The method for controlling the transfuse pressure in an additive manufacturing system of claim 46, wherein the target transfusion pressure at a first location along the x-axis of the three-dimensional part is an average of a target transfusion pressures calculated at the first location and target transfusion pressures calculated at a second and third location, wherein the second and third locations are immediately adjacent to the first location.
